(19) United States
(12) Patent Application Publication
(10) Pub. No.: US 2007/0127272 A1
(43) Pub. Date: Jun. 7, 2007

(54) LAMP FIXING MEMBER, AND BACK LIGHT ASSEMBLY AND LIQUID CRYSTAL DISPLAY APPARATUS HAVING THE SAME

(75) Inventors: Yong-Seok YANG, Asan-si, Chungcheongnam-do (KR); Sang-Hoon PARK, Yongin-si, Gyeonggi-do (KR); Jin-Ho HA, Suwon-si, Gyeonggi-do (KR); Jung-Tae KANG, Suwon-si, Gyeonggi-do (KR); Sang-Duk LEE, Yongin-si, Gyeonggi-do (KR); Joo-Young KIM, Cheonan-si, Chungcheongnam-do (KR); Su-Young YUN, Cheonan-si, Chungcheongnam-do (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/562,586

(22) Filed: Nov. 22, 2006

(30) Foreign Application Priority Data
Dec. 6, 2005 (KR) 10-2005-0117934
Dec. 8, 2005 (KR) 10-2005-0119195
Dec. 15, 2005 (KR) 10-2005-0123663

(51) Int. Cl. F21V 7/04

(52) U.S. Cl. 362/634; 362/614; 362/632

(57) ABSTRACT

A lamp fixing member includes a body portion, a lamp fixing portion and an upper supporting plate. The lamp fixing portion is disposed on the upper surface of the body portion and has a groove for fixing a lamp. The upper supporting plate is combined with the lamp fixing portion and fixes an upper portion of the lamp. The lamp fixing portion includes a combining portion for being combined with the upper supporting plate. The supporting plate and lamp fixing portion may be formed of a silicone material. Therefore, the efficiency of lamp assembly is enhanced by automated assembly process and a display quality is enhanced by reducing temperature deviation in the lamp fixing portion. The lamp fixing portion may further include a lower supporting plate combined with the lamp fixing portion to fix a lower portion of the lamp.

The present application claims priority to Korean Patent Application No. 2005-117934, filed on Dec. 6, 2005, Korean Patent Application No. 2005-119195, filed on Dec. 8, 2005, and Korean Patent Application No. 2005-123663, filed on Dec. 15, 2005, and all the benefits accruing therefrom under 35 U.S.C. § 119, the contents of each in its entirety are herein incorporated by reference.

### BACKGROUND OF THE INVENTION

1. Field of the Invention

The present invention relates to a lamp fixing member, a backlight assembly having the lamp fixing member and a liquid crystal display device having the lamp fixing member. More particularly, the present invention relates to a lamp fixing member capable of enhancing lamp assembling efficiency and display quality, a backlight assembly having the lamp fixing member and liquid crystal display device having the lamp fixing member.

2. Description of the Related Art

A liquid crystal display (“LCD”) device displays an image by using liquid crystal. The LCD device, as a display device, has many advantages in comparison with a cathode ray tube (“CRT”). The advantages of LCD devices over CRT display devices include thin thickness, lightweight, low driving voltage, low power consumption, etc., so that LCD devices are used in various display devises which include, for example, as a notebook computer, a monitor and television (“TV”).

An LCD panel of the LCD device does not emit light by itself, but the LCD panel uses light in order to display an image. Therefore, the LCD device requires a backlight assembly as a light source to supply the light to the LCD panel to display an image.

The backlight assembly includes a lamp emitting light. A conventional backlight assembly employs a cold cathode fluorescent lamp (“CCFL”) having a long cylindrical shape as a light source. The backlight assembly may be classified into an edge-illumination type and a direct-illumination type according to a lamp position.

The edge-illumination type backlight assembly includes one or two lamps disposed adjacent to a transparent plate (e.g., a light guide plate). The edge-illumination type backlight assembly emits the light generated by multi-reflection through one surface of the light guide plate. The direct-illumination type backlight assembly includes a plurality of lamps disposed directly under a liquid crystal display panel. In the direct-illumination type backlight assembly, a diffusion plate is disposed over the plurality of lamps and a reflection plate is disposed under the plurality of lamps, so that the light generated by the lamp is reflected by the reflection plate to advance toward the diffusion plate and is diffused by the diffusion plate. The edge-illumination type is used for a relatively small sized LCD device such as a notebook computer, a monitor, and so on, and the direct-illumination type backlight assembly is used for a relatively large sized LCD device, such as a TV set and so on.

In the direct-illumination type backlight assembly, the size of the diffusion plate increases when the size of the LCD device and the length of the lamp increase. Therefore, the backlight assembly requires a lamp fixing member to fix the lamp and to support the diffusion plate.

The lamp fixing member includes a lamp fixing portion to fix the lamp, and a diffusion plate supporting portion to support the diffusion plate. Generally, the lamp fixing portion has an open circular clip shape.

In the above-described structure, it is impossible to automatically combine the lamp with the lamp fixing portion, and therefore, the process of manufacturing the backlight assembly is more complex and the lead time is longer. Furthermore, the display quality becomes poor due to a dark portion in the image as a result of a temperature deviation occurring in the lamp portion fixed to the lamp fixing portion.

### BRIEF SUMMARY OF THE INVENTION

The present invention provides a lamp fixing member capable of enhancing the efficiency of assembly of a lamp fixed to the lamp fixing member and reducing a display error due to the lamp fixing member.

The present invention also provides a backlight assembly having the lamp fixing member.

The present invention also provides a LCD device having the backlight assembly.

In an exemplary embodiment of a lamp fixing member according to the present invention, the lamp fixing member includes a body portion, a lamp fixing portion, a lower supporting plate and an upper supporting plate. The lamp fixing portion is disposed on an upper surface of the body portion and has a groove for fixing a lamp. The lower supporting plate is combined with the lamp fixing portion and fixes a lower portion of the lamp. The upper supporting plate is combined with the lamp fixing portion and fixes an upper portion of the lamp.

The lamp fixing portion may include a combining portion for being combined with the upper supporting plate and the lower supporting plate.

The lower supporting plate may include at least one lamp supporting portion fixed to the groove of the lamp fixing portion and supporting the lower portion of the lamp, and a lower connecting portion connecting the lamp supporting portion with each other. The lower supporting plate includes a lower combining hole for being combined with the lamp fixing portion. The lower combining hole includes lower combining holes disposed at both sides with respect to the lamp supporting portion.

The upper supporting plate may further include at least one lamp covering portion covering the upper portion of the lamp and an upper connecting portion connecting the lamp covering portion with each other. The upper supporting plate includes an upper combining hole for being combined with the lamp fixing portion. The upper combining hole includes upper combining holes disposed at both sides with respect to the lamp covering portion.

The lamp fixing member further includes a diffusion plate supporting portion protruding from the upper surface of the body portion. The lower supporting plate includes a first hole into which the diffusion plate supporting portion is inserted to extend therethrough, and the upper supporting plate includes a second hole into which the diffusion plate supporting portion is inserted to extend therethrough.

The lamp fixing member may further include a body combining portion disposed under a lower surface of the body portion for being combined with a receiving container.

In another exemplary embodiment of a lamp fixing member according to the present invention, the lamp fixing member includes a body portion, a lamp fixing portion, a diffusion plate supporting portion and a supporting plate. The lamp fixing portion is disposed on the upper surface of the body portion and has a groove for fixing a lamp. The diffusion plate supporting portion is disposed on the upper surface of the body portion and protrudes beyond a height of the lamp fixing portion. The supporting plate is disposed on the upper portion of the lamp fixing portion and fixes the upper portion of the lamp inserted into the groove.

In an exemplary embodiment, the lamp fixing portion includes a first hook combining portion for being combined with the supporting plate and the supporting plate includes a second hook combining portion being combined with the first hook combining portion.

In another exemplary embodiment, the body portion includes a third hook combining portion for combining with the supporting plate and the supporting plate includes a fourth hook combining portion combined with the third hook combining portion.

In still another exemplary embodiment of a lamp fixing member according to the present invention, the lamp fixing member includes a body portion, a lamp fixing portion, a diffusion plate supporting portion and a fixing band. The lamp fixing portion is disposed on the upper surface of the body portion and has a groove for fixing a lamp. The diffusion plate supporting portion is disposed on the upper surface of the body portion and protrudes beyond a height of the lamp fixing portion. The fixing band which is inserted into the groove of the lamp fixing portion, fixes the upper portion of the lamp and has a string shape.

In an exemplary embodiment of a backlight assembly according to the present invention, the backlight assembly includes a receiving container, a plurality of lamps, a diffusion plate and a lamp fixing member. The receiving container has a bottom plate and a sidewall to provide a receiving space. The plurality of lamps is received on the bottom plate of the receiving container. The diffusion plate is disposed over the plurality of lamps. The lamp fixing member is combined with the bottom plate of the receiving container. The lamp fixing member includes a body portion extending along a direction that is substantially perpendicular to a longitudinal direction of the lamps, at least one lamp fixing portion disposed on the upper surface of the body portion and having a groove for fixing the plurality of lamps, a lower supporting plate combined with the lamp fixing portion and fixing the lower portion of the lamp, and an upper supporting plate combined with the lamp fixing portion and fixing the upper portion of the lamp.

In another exemplary embodiment of a backlight assembly according to the present invention, the backlight assembly includes a receiving container, a plurality of lamps, a diffusion plate and a lamp fixing member. The plurality of lamps is received on the bottom plate of the receiving container. The diffusion plate is disposed over the plurality of lamps. The lamp fixing member is combined with the bottom plate of the receiving container. The lamp fixing member includes a body portion extending along a direction that is substantially perpendicular to a longitudinal direction of the lamps, at least one lamp fixing portion disposed on the upper surface of the body portion and having a groove for fixing the plurality of lamps, a diffusion plate supporting portion disposed on the upper surface of the body portion and supporting the diffusion plate, and a supporting plate disposed on the upper portion of the lamp fixing portion and fixing the upper portion of the lamp inserted into the groove.

In still another exemplary embodiment of a backlight assembly according to the present invention, the backlight assembly includes a receiving container, a plurality of lamps, a diffusion plate and a lamp fixing member. The plurality of lamps is received on the bottom plate of the receiving container. The diffusion plate is disposed over the plurality of lamps. The lamp fixing member is combined with the bottom plate of the receiving container. The lamp fixing member includes a body portion extending along a transverse direction of the plurality of lamps, at least one lamp fixing portion disposed on the upper surface of the body portion and having a groove for fixing the plurality of lamps, a diffusion plate supporting portion disposed on the upper surface of the body portion and supporting the diffusion plate, and a fixing band which is inserted into the groove of the lamp fixing portion, fixes the upper portion of the lamp and has a string shape.

In an exemplary embodiment of an LCD device according to the present invention, the LCD device includes a backlight assembly which provides light, a display unit disposed over the backlight assembly for displaying an image, and a top chassis which fixes the display unit. The backlight assembly includes a receiving container, a plurality of lamps and a lamp fixing member. The plurality of lamps is received on the bottom plate of the receiving container. The lamp fixing member is combined with the bottom plate of the receiving container. The lamp fixing member includes a body portion which extends along a direction that is substantially perpendicular to the lamps, at least one lamp fixing portion disposed on the upper surface of the body portion and having a groove for fixing the plurality of lamps, a lower supporting plate combined with the lamp fixing portion and fixes the lower portion of the lamp, and an upper supporting plate combined with the lamp fixing portion and fixes the upper portion of the lamp.

In another exemplary embodiment of an LCD device according to the present invention, the LCD device includes a backlight assembly which provides light, a display unit disposed over the backlight assembly for displaying an image, and a top chassis which fixes the display unit. The backlight assembly includes a receiving container, a plurality of lamps, a diffusion plate and a lamp fixing member. The plurality of lamps is received on the bottom plate of the receiving container. The diffusion plate is disposed over the plurality of lamps. The lamp fixing member includes a body portion combined with the receiving container and extends along a transverse direction of the plurality of lamps, at least one lamp fixing portion disposed on the upper surface of the body portion and has a groove for fixing the plurality of lamps, a diffusion plate supporting portion disposed on the upper surface of the body portion and supports the diffusion plate, and a supporting plate disposed on the upper portion of the lamp fixing portion and fixes the upper portion of the lamp inserted into the groove.

In still another exemplary embodiment of an LCD device according to the present invention, the LCD device includes a backlight assembly which provides light, a display unit disposed over the backlight assembly fro displaying an image, and a top chassis which fixes the display unit. The backlight assembly includes a receiving container, a plurality of lamps, a diffusion plate and a lamp fixing member. The plurality of lamps is received on the bottom plate of the receiving container. The diffusion plate is combined with the receiving container. The diffusion plate is disposed over the plurality of lamps. The lamp fixing member includes a body portion combined with the receiving container and extends along a transverse direction of the plurality of lamps, at least one lamp fixing portion disposed on the upper surface of the body portion and has a groove for fixing the plurality of lamps, a diffusion plate supporting portion disposed on the upper surface of the body portion and supports the diffusion plate, and a fixing band which is inserted into the groove of the lamp fixing portion, fixes the upper portion of the lamp and has a string shape.

Therefore, efficiency of assembly of a lamp is enhanced by automated assembly process and a display quality is enhanced by reducing temperature deviation in the lamp fixing portion and eliminating a split of the diffusion plate.

### BRIEF DESCRIPTION OF THE DRAWINGS

The above and other aspects, features and advantages of the present invention will become more apparent by describing exemplary embodiments thereof with reference to the accompanying drawings, in which:

FIG. 1 is an exploded perspective view illustrating a backlight assembly according to an exemplary embodiment of the present invention;

FIG. 2 is a perspective view illustrating an exemplary embodiment of a lamp fixing member in FIG. 1;

FIG. 3 is a side view of the lamp fixing member in FIG. 2;

FIG. 4 is an exploded perspective view illustrating the lamp fixing member in FIG. 2;

FIG. 5 is a perspective view illustrating a lamp receptacle in FIG. 1;

FIG. 6 is a perspective view illustrating another exemplary embodiment of a lamp fixing member;

FIG. 7 is an enlarged view illustrating portion A in FIG. 6;

FIG. 8 is an exploded perspective view illustrating the lamp fixing member in FIG. 6;

FIG. 9 is a perspective view illustrating still another exemplary embodiment of a lamp fixing member;

FIG. 10 is an exploded perspective view illustrating the lamp fixing member in FIG. 9;

FIG. 11 is a perspective view illustrating still another exemplary embodiment of a lamp fixing member;

FIG. 12 is a side view illustrating the lamp fixing member in FIG. 11;

FIG. 13 is an enlarged view illustrating portion B in FIG. 11; and

FIG. 14 is an exploded perspective view illustrating a LCD device according to an exemplary embodiment of the present invention.

### DETAILED DESCRIPTION OF THE INVENTION

It should be understood that the exemplary embodiments of the present invention described below may be modified in many different ways without departing from the inventive principles disclosed herein, and the scope of the present invention is therefore not limited to these particular flowing exemplary embodiments. Rather, these exemplary embodiments are provided so that this disclosure will be thorough and complete, and will fully convey the concept of the invention to those skilled in the art. In the drawings, the size and relative sizes of layers and regions may be exaggerated for clarity.

It will be understood that when an element or layer is referred to as being “on,” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as being limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the exemplary embodiments of the present invention will be described particularly with reference to the accompanied drawings.

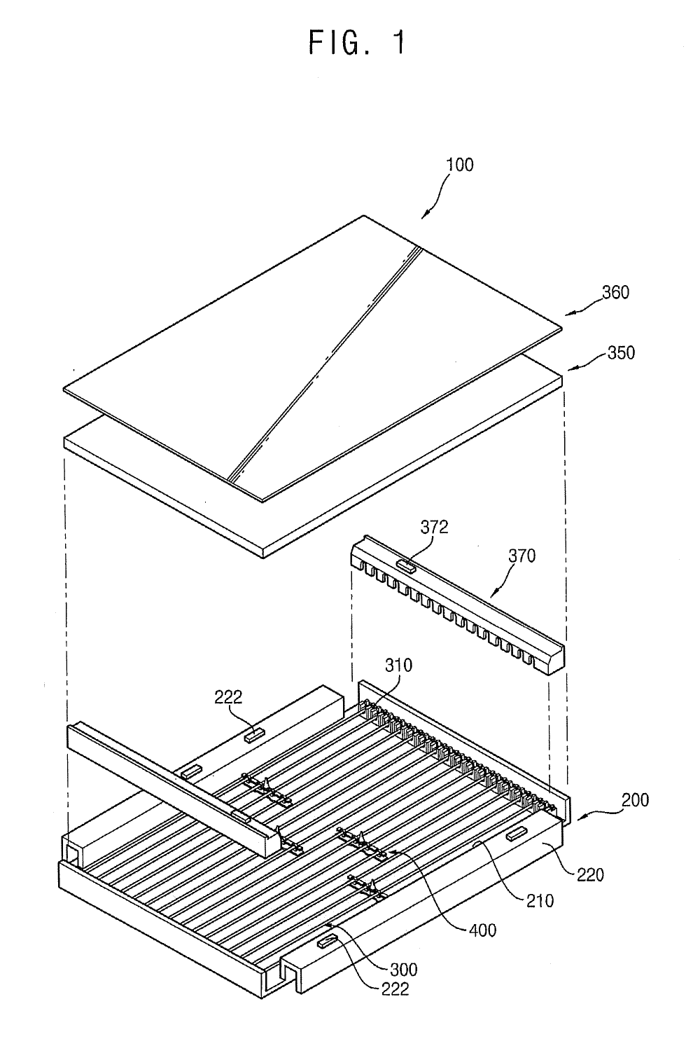

FIG. 1 is an exploded perspective view illustrating a backlight assembly according to an exemplary embodiment of the present invention.

Referring to FIG. 1, a backlight assembly 100 according to an exemplary embodiment of the present invention includes a receiving container 200, a plurality of lamps 300, a diffusion plate 350 and a lamp fixing member 400.

The receiving container 200 includes a bottom plate 210 and sidewalls 220. The sidewalls 220 extend from respective peripheral portions of the bottom plate 210 so that the bottom plate 210 and the sidewalls 220 together provide a receiving space. The receiving container 200 may be formed of a metal that has a high strength for preventing easy deformation thereof.

The backlight assembly 100 may further include first diffusion plate guiding members 222 disposed on the sidewalls 220 of the receiving container 200. The first diffusion plate guiding members 222 may be disposed on two corresponding sidewalls 220 of the receiving container 200 extending along a first direction. For example, when the receiving container 200 has a rectangular shape, the first diffusion plate guiding members 222 may be positioned along each relatively long side of the receiving container 200. The first diffusion plate guiding members 222 protrude upwardly from the sidewalls 220 of the receiving container 200 to properly guide the diffusion plate 350 to a predetermined position on the receiving container 200.

Lamps 300 are disposed on the bottom plate 210 of the receiving container 200, and extend substantially in parallel to each other. The lamps 300 emit light in response to a driving signal provided by an external source. The lamps 300 may be a cold cathode fluorescent lamp (“CCFL”). In one exemplary embodiment, the CCFL having a long cylindrical shape may be employed as the lamps 300. Alternatively, an external electrode fluorescent lamp (“EEFL”) having an external electrode formed at each end portion thereof may be employed as the lamps 300. Furthermore, the lamps 300 may have a U-shape having a curved structure.

Both end portions of the lamps 300 are fixed by a lamp receptacle 310, which is fixed on the receiving container 200.

The diffusion plate 350 is disposed over the lamps 300. The diffusion plate 350 diffuses light generated by the lamps 300, and enhances a uniformity of brightness and intensity. The diffusion plate 350 may have a predetermined thickness and may be separated from the lamps 300 by a predetermined distance. For example, the diffusion plate 350 may have a plate shape.

The diffusion plate 350 may be formed of a transparent material to transmit light. The diffusion plate 350 may include a diffusion agent to promote light emission therefrom. For example, the diffusion plate 350 may be formed of polymethyl methacrylate (“PMMA”).

The backlight assembly 100 may further include at least one optical sheet 360 disposed on the diffusion plate 350. The optical sheet 360 may change a direction of the light diffused by the diffusion plate 350, and the optical sheet 360 may enhance a uniformity of brightness and intensity. The optical sheet 360 may include a condensing sheet for improving the brightness and intensity of the light. The condensing sheet may condense light that exits from the diffusion plate 350 along a perpendicular direction with respect to the upper surface of the diffusion plate 350. Alternatively, the optical sheet 360 may further include a diffusion sheet to further diffuse the light, which is first diffused through the diffusion plate 350. However, according to the brightness and intensity characteristics of the light, the backlight assembly 100 may include the optical sheet 360 having various functions such as a reflective polarizing sheet and so on.

The lamp fixing member 400 is fixed on the bottom plate 210 of the receiving container 200 to fix the lamps 300. As the length of the lamps 300 increases, the lamps 300 may sag or deform. Therefore, the lamp fixing member 400 is disposed at a center portion of the lamps 300, and stably fixes the lamps 300 to prevent the lamps 300 from sagging or deforming.

The number of the lamp fixing members 400 is dependent on a number of the lamps 300. For example, four lamps 300 may be fixed to one lamp fixing member 400. When more than two lamp fixing members 400 are disposed, the lamp fixing members 400 may be arranged in a zigzag shape along a second direction that is substantially perpendicular to the first direction that corresponds to a longitudinal direction of the lamps 300, as illustrated in FIG. 1.

Each lamp 300 is fixed by one lamp fixing member 400. However, when the length of each lamp 300 increases, more than one lamp fixing member 400 fixes one lamp 300. In other words, more than one lamp fixing member 400 supports one lamp 300. In the above mentioned case, each lamp fixing member 400 may be arranged in a zigzag shape along the second direction.

The backlight assembly 100 may further include a side mold 370 corresponding to both edge portions of the lamps 300. The side mold 370 may cover both end portions of the lamps 300, and is combined with the receiving container 200. When the side mold 370 covers both end portions of the lamps 300, an electrode portion of the lamps 300, which has a relatively low brightness and intensity is covered by the side mold 370. Therefore, the side mold 370 may improve the luminance uniformity and intensity of the light.

The side mold 370 supports the edge portion of the diffusion plate 350 which is disposed on the side mold 370, and guides the diffusion plate 350 to a receiving position. Second diffusion plate guiding members 372 may be formed on two corresponding side molds 370 along the second direction. When the receiving container 200 has a rectangular shape, the second diffusion plate guiding members 372 may be positioned along each relatively short side of the receiving container 200. The second diffusion plate guiding members 372 protrude upwardly from an upper surface of the side mold 370 to properly guide the diffusion plate 350 to the predetermined position on the receiving container 200.

The backlight assembly 100 may further include a middle mold (not shown) to fix the diffusion plate 350 and the optical sheet 360. The middle mold may be combined with the receiving container 200 on an upper portion of the optical sheet 360. The middle mold fixes the edge portion of the diffusion plate 350 and the optical sheet 360.

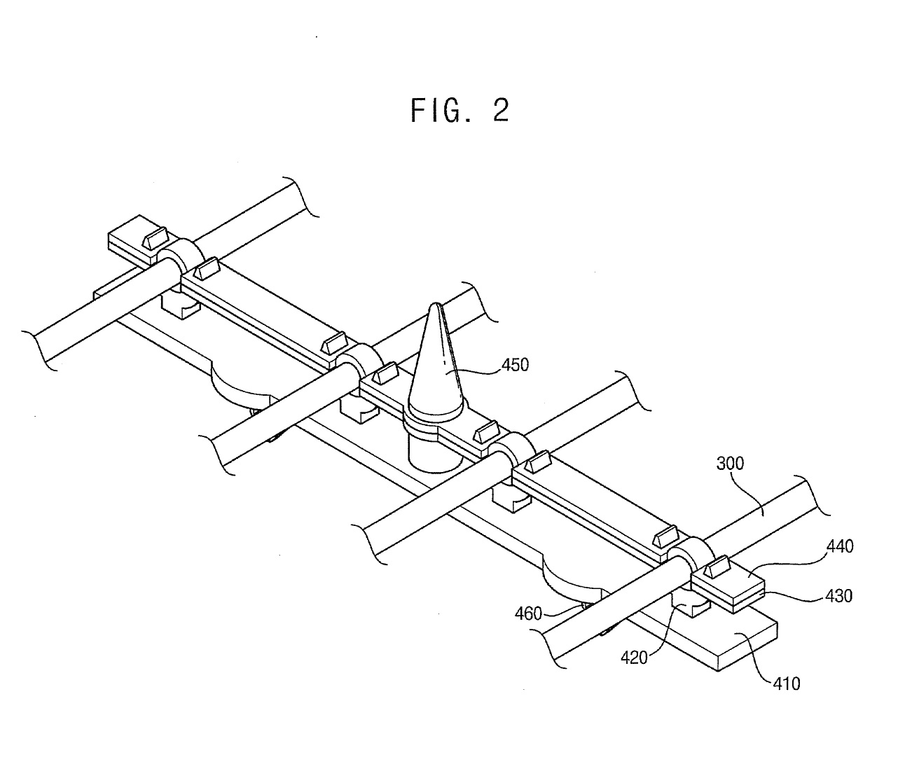

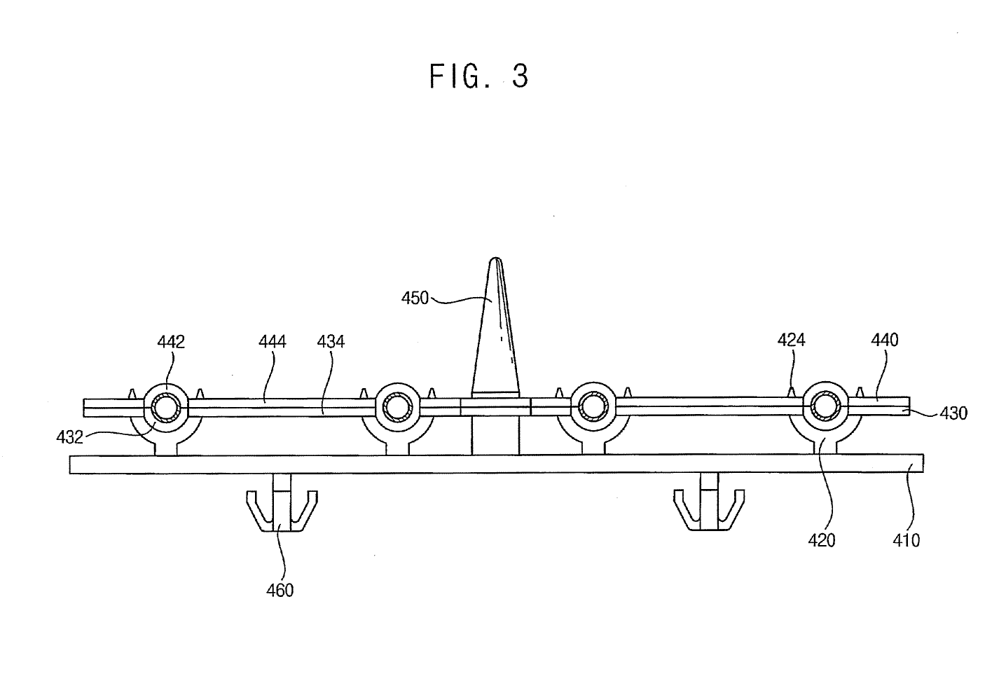

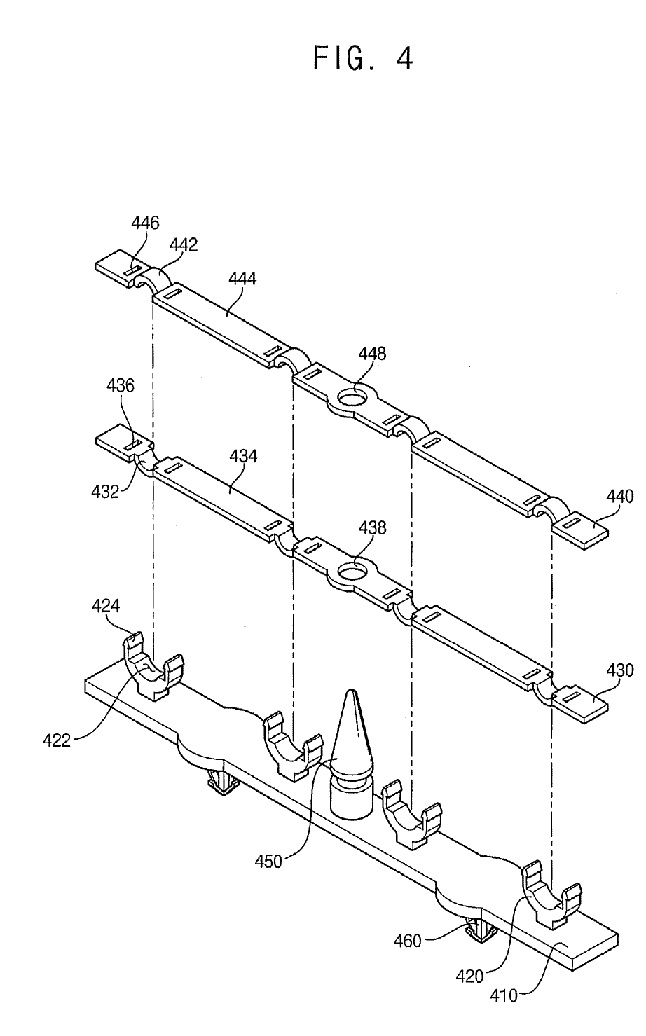

FIG. 2 is a perspective view illustrating an exemplary embodiment of a lamp fixing member in FIG. 1. FIG. 3 is a side view of a lamp fixing member in FIG. 2. FIG. 4 is an exploded perspective view illustrating the lamp fixing member in FIG. 2.

Referring to FIGS. 2 to 4, the lamp fixing member 400 includes a body portion 410, a lamp fixing portion 420, a lower supporting plate 430 and an upper supporting plate 440.

The body portion 410 extends along a transverse direction to a longitudinal direction of the lamps 300.

For example, more than one lamp fixing portion 420 may be disposed on an upper surface of the body portion 410. The lamp fixing portion 420 may have a groove 422 at the surface to fix the lamps 300.

The lamp fixing portion 420 may include combining portions 424 to be combined with the lower supporting plate 430 and the upper supporting plate 440. The combining portions 424 are disposed at both sides with respect to the groove 422.

The lamp fixing portion 420 may be disposed at both sides with respect to the diffusion plate supporting portion 450, and more than one of the lamp fixing portions 420 may be disposed at each side. For example, the lamp fixing member 400 may have two lamp fixing portions 420 disposed at each side with respect to the diffusion plate supporting portion 450, so the lamp fixing member 400 may have four lamp fixing portions 420 in total. Alternatively, the lamp fixing member 400 may have a various number of lamp fixing portions 420.

The body portion 410 and the lamp fixing portion 420 are formed of a same material, and are integrally formed with each other. For example, the body portion 410 and the lamp fixing portion 420 include a plastic material, and are manufactured by an injection molding method.

The lower supporting plate 430 disposed beneath the upper supporting plate 440 is combined with the lamp fixing portion 420, and fixes a lower portion of the lamp 300. The lower supporting portion 430 includes a lamp supporting portion 432 and a lower connecting portion 434.

The lamp supporting portion 432 is inserted into the groove 422 in the lamp fixing portion 420 to support the lamp 300. The lamp supporting portion 432 has a same curvature as that of an outer surface of the lamp 300 to support the lamp 300. The lamp supporting portion 432 has a half-circular convex shape, corresponding to a lamp covering portion 442 of the upper supporting plate 440.

The lower connecting portion 434 extends in parallel with the body portion 410, and is connected with the lamp supporting portion 432.

The lower supporting portion 430 may have a lower combining hole 436 to be combined with the lamp fixing portion 420. The lower combining hole 436 corresponds to the combining portion 424 of the lamp fixing portion 420, and is disposed at both sides with respect to the lamp supporting portion 432. In other words, the lower combining hole 436 is disposed at the lower connecting portion 434 adjacent to the lamp supporting portion 432.

The upper supporting plate 440 is fixed to the lamp fixing portion 420, and fixes the upper portion of the lamp 300. The upper supporting plate 440 includes the lamp covering portion 442 and an upper connecting portion 444.

The lamp covering portion 442 is disposed on the upper portion of the lamp 300, and covers the upper portion of the lamp 300. The lamp covering portion 442 has a half-circular concave shape, and is correspondingly disposed over the lamp supporting portion 432. Therefore, the lamp 300 is covered with the lamp supporting portion 432 and the lamp covering portion 442.

The upper connecting portion 444 extends in parallel with the lower connecting portion 434, and is connected with the lamp covering portion 432. The upper connecting portion 444 and the lower connecting portion 434 make contact with each other when the upper supporting plate 440 and the lower supporting plate 420 are inserted into the lamp fixing portion 420.

The upper supporting plate 440 may have an upper combining hole 446 to be combined with the lamp fixing portion 420. The upper combining hole 446 corresponds to the combining portion 424 of the lamp fixing portion 420, and is disposed at both sides with respect to the lamp covering portion 442. In other words, the upper combining hole 446 is disposed at the upper connecting portion 444 adjacent to the lamp covering portion 442.

The lower supporting plate 430 and the upper supporting portion 440 are formed of a material with a predetermined elasticity to absorb an external impact. For example, the lower supporting plate 430 and the upper supporting portion 440 may be formed of a silicone material.

Since the lower supporting plate 430 and the upper supporting plate 440 that make direct contact with the lamp 300 with a silicone material, the temperature deviation between the fixed portion and the other portion of the lamp 300 is reduced, and the display deterioration such as a dark portion due to the temperature deviation is also eliminated.

The lamp fixing portion 400 may further include the diffusion plate supporting portion 450. The diffusion plate supporting portion 450 protrudes from the upper surface of the body portion 410, and supports the diffusion plate 350 that is shown in FIG. 1. When the diffusion plate 350 size increases, the diffusion plate 350 may sag. Therefore, the diffusion plate supporting portion 450 prevents the sagging of the diffusion plate 350, and maintains a uniform distance between the lamp 300 fixed to the lamp fixing portion 420 and the diffusion plate 350. For example, the diffusion plate supporting portion 450 may have a conical shape, as illustrated.

As best seen with reference to FIG. 4, the lower supporting plate 430 may have a first hole 438 into which the diffusion plate supporting portion 450 is inserted, and the upper supporting plate 440 may have a second hole 448 into which the diffusion plate supporting portion 450 is inserted. Since the protrusion height of the diffusion plate supporting portion 450 is higher than that of the lamp fixing portion 420, the diffusion plate supporting portion 450 protrudes high enough to pass through the first hole 438 and the second hole 448 when the upper supporting plate 430 and the upper supporting plate 440 are fixed to the lamp fixing portion 420.

To be combined with the receiving container 200, which is shown in FIG. 1, the lamp fixing member 400 may further include at least one body combining portion 460, which is disposed beneath the body portion 410. After passing through the opening portion in the bottom plate 210 of the receiving container 200, the body combining portion 460 having a hook shape is combined with the receiving container 200. The body combining portion 460 may have various locations and numbers.

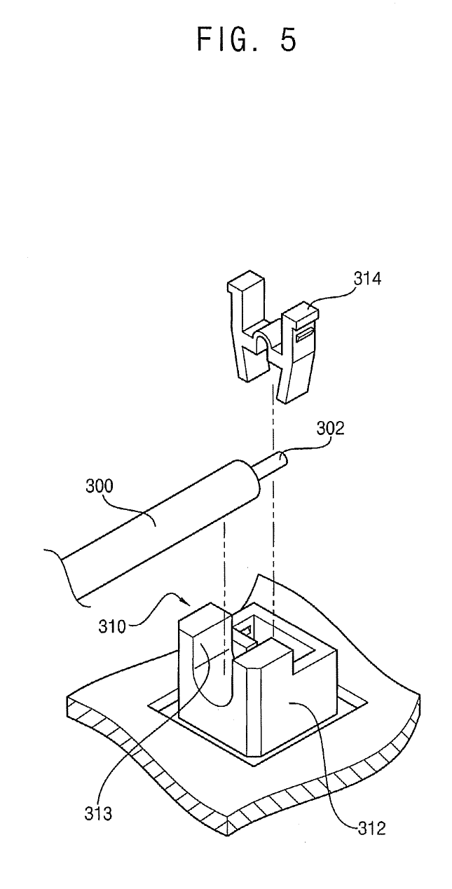

FIG. 5 is a perspective view illustrating a lamp receptacle in FIG. 1.

Referring to FIGS. 1 and 5, a lamp receptacle 310 is mounted on a circuit substrate and is disposed inside of the receiving container 200 through the opening portion of the receiving container 200. The number of lamp receptacles 310 is the same as the number of lamps 300.

The lamp receptacle 310 includes a receptacle body portion 312 and a receptacle fixing portion 314. The receptacle body portion 312 includes a lamp hole 313 into which the lamp 300 is inserted. The lamp 300 is mounted on the receptacle body portion 312, and then the receptacle fixing portion 314 is combined with the receptacle body portion 312 to fix a lead line 302 of the lamp 300. The lead line 302 of the lamp 300 is combined with an electrical conduction terminal disposed inside of the receptacle body 312 for electrically connection with the electric conduction terminal.

In exemplary embodiments, the lamp 300 is assembled by an automated manufacturing machine. First, the lamp fixing member 400, which includes the lamp fixing portion 420 and the lower supporting plate 430 combined with each other, is assembled to the receiving container 200, and the lamp receptacles 310 are assembled to the receiving container 200.

Then the automated manufacturing machine disposes the lamps 300 on the lower supporting plate 430 of the lamp fixing member 400 and on the receptacle body portion 312 of the lamp receptacle 310.

Then, the upper supporting plate 440 of the lamp fixing member 400 is assembled to the lamp fixing portion 420, and the receptacle fixing portion 314 of the lamp receptacle 310 is assembled to the receptacle body portion 312.

Therefore, the assembly process of the lamp 300 may be simplified and a time required for manufacturing the assembly may be reduced.

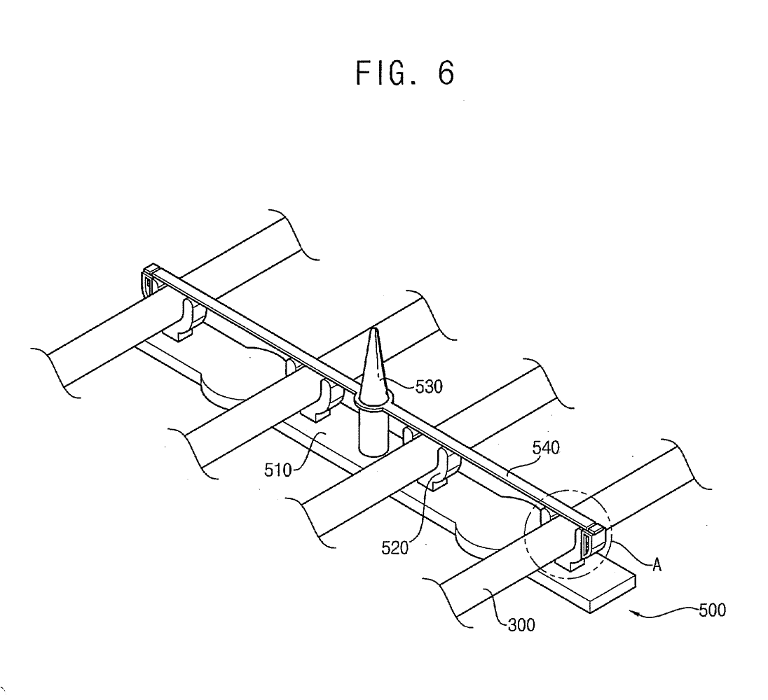

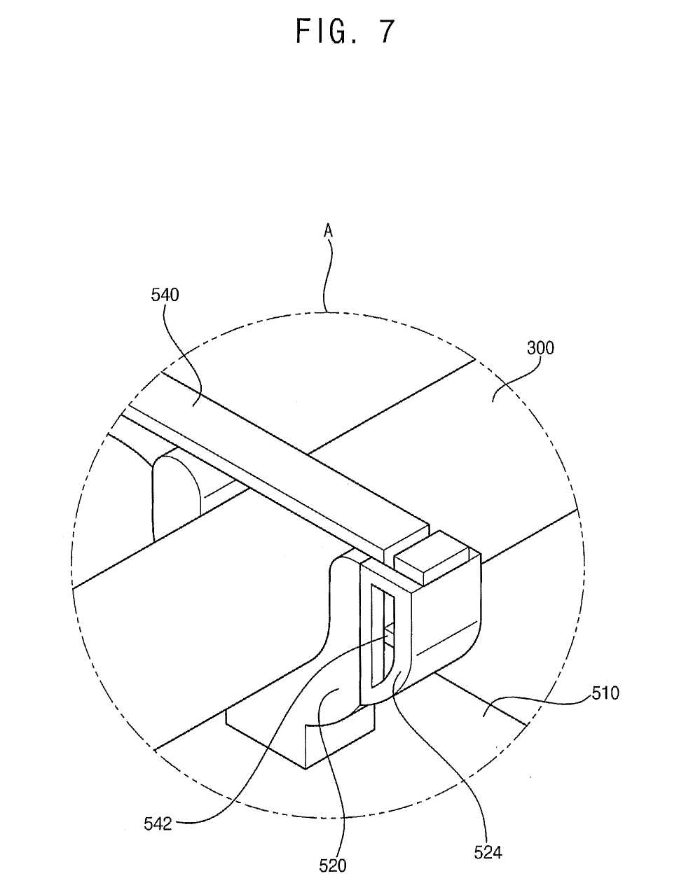

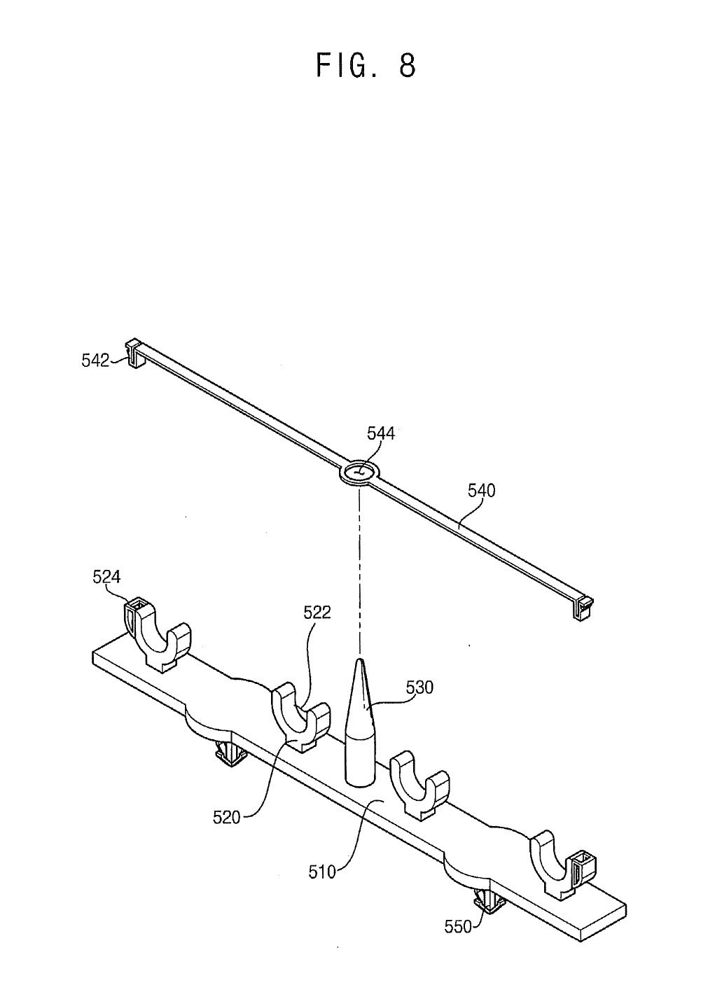

FIG. 6 is a perspective view illustrating another exemplary embodiment of a lamp fixing member. FIG. 7 is an enlarged view illustrating portion A in FIG. 6. FIG. 8 is an exploded perspective view illustrating the lamp fixing member in FIG. 6.

Referring to FIGS. 6, 7 and 8, a lamp fixing member 500 includes a body portion 510, a lamp fixing portion 520, a diffusion plate supporting portion 530 and a supporting plate 540.

The body portion 510 extends along a direction that is substantially transverse or perpendicular to a longitudinal direction of the plurality of lamps 300.

More than one lamp fixing portion 520 is disposed on an upper surface of the body portion 510. Each of the lamp fixing portions 520 has a groove 522 to fix the lamp 520. The groove 522 of the lamp fixing portion 520 is molded to have a larger size than that of the corresponding lamp 300, so that the lamp 300 may be easily inserted into the groove 522.

A plurality of the lamp fixing portions 520 may be disposed at both sides with respect to the diffusion plate supporting portion 530, and more than one of the lamp fixing portions 520 may be disposed at each side. For example as illustrated in FIGS. 6 and 8, the lamp fixing member 500 has two lamp fixing portions 520 disposed at each side with respect to the diffusion plate supporting portion 530, so the lamp fixing member 500 has four lamp fixing portions 520 in total. Alternatively, the lamp fixing member 500 may have a various number of the lamp fixing portions 520.

The lamp fixing portion 520 may include a first hook combining portion 524 to be combined with the supporting plate 540. The first hook combining portion 524 is formed at an outermost lamp fixing portion 520, which is disposed at the outer or outboard side. Alternatively, the first hook combining portion 524 may be formed at all the lamp fixing portions 520.

The diffusion plate supporting portion 530 is disposed on the upper surface of the body portion 510. The diffusion plate supporting portion 530 protrudes higher than that of the lamp fixing portion 520, and supports the diffusion plate 350 which is shown in FIG. 1. When the diffusion plate 350 size increases, the diffusion plate may sag. Therefore, the diffusion plate supporting portion 530 prevents the diffusion plate 350 from sagging, and maintains a uniform distance between the lamp 300 fixed to the lamp fixing portion 520 and the diffusion plate 350. For example, the diffusion plate supporting portion 450 may be a conical shape, as illustrated in FIGS. 6 and 8.

The body portion 510, the lamp fixing portion 520 and the diffusion plate supporting portion 530 are formed of a same material and are integrally manufactured. For example, the body portion 510, the lamp fixing portion 520 and the diffusion plate supporting portion 530 include a plastic material and are manufactured by an injection molding method.

The supporting plate 540 is disposed on an upper portion of the lamp fixing portion 520, and fixes the upper portion of the lamp 300 inserted into the groove 522. The supporting plate 540 may include a second hook combining portion 542 to be combined with the lamp fixing portion 520. The second hook combining portion 542 is correspondingly disposed at both edge portions of the supporting plate 540 to align with a respective first hook combining portion 524, which is fixed outside of the lamp fixing portion 520.

The supporting plate 540 is combined with the first hook combining portion 524 and the second hook combining portion 542, and is disposed and fixed on the upper portion of the lamp fixing portion 520. The first hook combining portion 524 has a groove into which the second hook combining portion 542 is inserted easily, and the second hook combining portion 542 has a protrusion shape, which is inserted into the groove of the first hook combining portion 524.

The supporting plate 540 has a diffusion plate hole 544 into which the diffusion plate supporting portion 530 is inserted. Since the protrusion height of the diffusion plate supporting portion 530 is higher than that of the lamp fixing portion 520, the diffusion plate supporting portion 530 protrudes high enough to pass through the diffusion plate hole 544, when the supporting plate 540 is fixed to the lamp fixing portion 520.

The supporting plate 540 is formed of a material with a predetermined elasticity to absorb an external impact. For example, the supporting plate 540 may be formed of a silicone material. Furthermore, the supporting plate 540 has a smaller width to reduce contact area between the lamp 300 and the supporting plate 540.

To be combined with the receiving container 200, which is shown in FIG. 1 the lamp fixing member 500 may further include at least one body combining portion 550 disposed beneath a lower surface of the body portion 510. After passing through the opening portion in the bottom plate 210 of the receiving container 200, the body combining portion 550 having a hook shape is combined with the receiving container 200. The body combining portion 550 may have various locations and numbers.

In exemplary embodiments, the lamp 300 is assembled by an automated manufacturing machine. First, the lamp fixing member 500 from which the supporting plate 540 is separated, is assembled to the receiving container 200, and the lamps 300 are inserted into the groove 522 of the lamp fixing portion 520 by the automated manufacturing machine. Then, the supporting plate 540 is assembled to the lamp fixing portion 520.

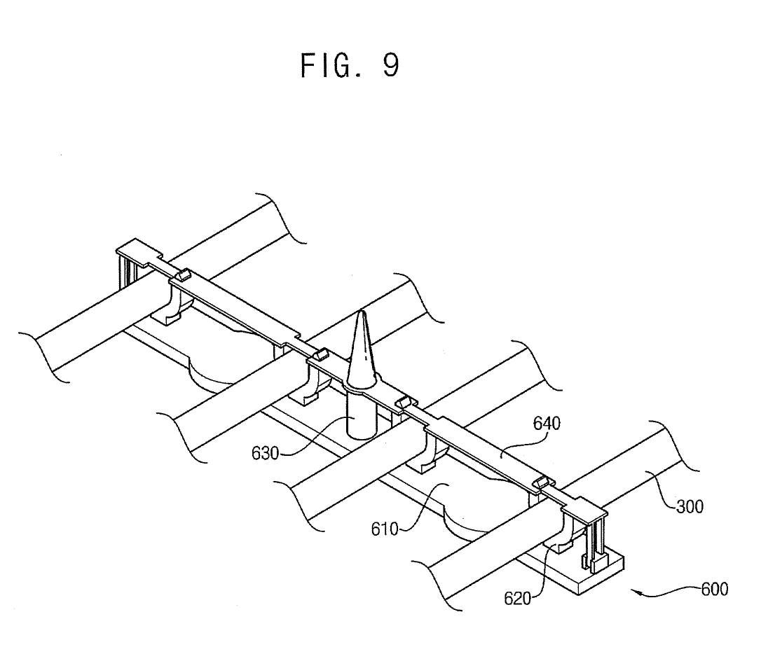

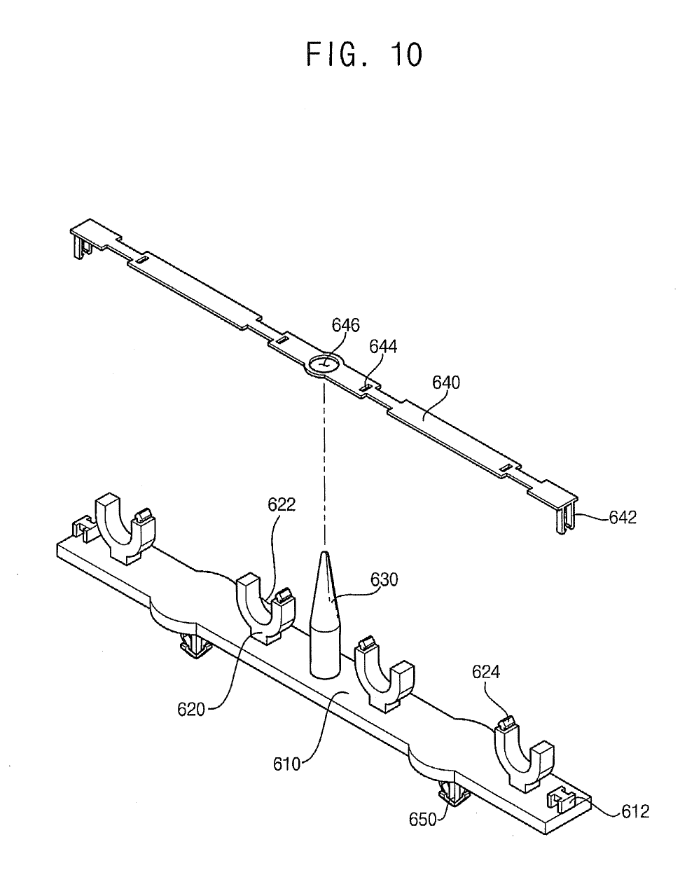

FIG. 9 is a perspective view illustrating still another exemplary embodiment of a lamp fixing member in FIG. 1. FIG. 10 is an exploded perspective view illustrating the lamp fixing member in FIG. 9.

Referring to FIGS. 9 and 10, a lamp fixing member 600 includes a body portion 610, a lamp fixing portion 620, a diffusion plate supporting portion 630 and a supporting plate 640.

The body portion 610 extends along a direction that is substantially transverse or perpendicular to a longitudinal direction of the lamps 300. The body portion 610 includes a third hook combining portion 612 to be combined with the supporting plate 640. The third hook combining portion 612 is disposed at both edge portions of the body portion 610.

More than one lamp fixing portion 620 is disposed on an upper surface of the body portion 610. The lamp fixing portion 620 has a groove 622 to fix the lamp 300. The groove 622 of the lamp fixing portion 620 has a larger size than that of the lamp 300, so that the lamp 300 may be easily inserted into the groove 622.

The lamp fixing portion 620 may be disposed on both sides with respect to the diffusion plate supporting portion 630, and more than one of the lamp fixing portions 620 may be disposed on each side. For example, the lamp fixing member 600 may have two lamp fixing portions 620 disposed on each side with respect to the diffusion plate supporting portion 630, so that the lamp fixing member 600 may have four lamp fixing portions 620 in total. Alternatively, the lamp fixing member 600 may have a various number of lamp fixing portions 620.

The lamp fixing portion 620 may further include a combining protrusion 624 to be combined with the supporting plate 640. The combining protrusion 624 is disposed on a top or terminal end of the lamp fixing portion 620. The combining protrusion 624 protrudes from the lamp fixing portion 620 and toward the supporting plate 640. The combining protrusion 624 is formed at least one side of the lamp fixing portion 620 with respect to the groove 622 of the lamp fixing portion 620.

The diffusion plate supporting portion 630 is disposed on an upper surface of the body portion 610. The diffusion plate supporting portion 630 protrudes with a height higher than the lamp fixing portion 620 and supports the diffusion plate 350 which is shown in FIG. 1. For example, the diffusion plate supporting portion 630 may have a conical shape, as illustrated.

The body portion 610, the lamp fixing portion 620 and the diffusion plate supporting portion, 630 are formed of a same material, and are integrally manufactured. For example, the body portion 610, the lamp fixing portion 620 and the diffusion plate supporting portion 630 include a plastic material and are manufactured by an injection molding.

The supporting plate 640 is disposed on the upper portion of the lamp fixing portion 620, and fixes the upper portion of the lamp 300 inserted into the groove 622. The supporting plate 640 may include a fourth hook combining portion 642 to be combined with a third hook combining portion 612. The fourth hook combining portion 642 is correspondingly disposed at both edge portions of the supporting plate 640 to align with the third hook combining portion 612, which are fixed outside of the body portion 610 and aligned with a respective fourth hook combining portion 642.

The supporting plate 640 has a combining hole 644, into which the combining protrusion 624 disposed on the lamp fixing portion 620 is inserted. The supporting plate 640 is fixed to the upper portion of the lamp fixing portion 620 more stably along a length thereof through a combination of the combining protrusion 624 and the combining hole 644.

The supporting plate 640 has a diffusion plate hole 646, into which the diffusion plate supporting portion 630 is inserted. Since the protrusion height of the diffusion plate supporting portion 630 is higher than that of the lamp fixing portion 620, the diffusion plate supporting portion 630 protrudes high enough to pass through the diffusion plate hole 646, when the supporting plate 640 is fixed with the lamp fixing portion 620.

For example, the supporting plate 640 may be formed of a material with a predetermined elasticity to absorb an external impact on the lamp 300. For example, the supporting plate 640 may be formed of a silicone material.

For example, the supporting plate 640 has a first width, and a second width that is smaller than the first width at a region corresponding to the lamp fixing portion 620 to reduce the direct contact region with the lamp 300.

To be combined with the receiving container 200, which is shown in FIG. 1, the lamp fixing member 600 may further include at least one body combining portion 650 disposed at a lower surface of the body portion 610. The body combining portion 650 having a hook shape, passes through the opening portion of the bottom plate 210 and is combined with the bottom plate 210. The body combining portion 650 may have various locations and numbers.

In exemplary embodiments, the lamp 300 is assembled by an automated manufacturing machine. First, the lamp fixing member 600 separated from the supporting plate 640 is assembled to the receiving container 200. Then, the lamps 300 are inserted into the grooves 622 of the respective lamp fixing portions 620 by the automated manufacturing machine (not shown). Then, the supporting plate 640 is assembled to the body portion 610 and the lamp fixing portion 620.

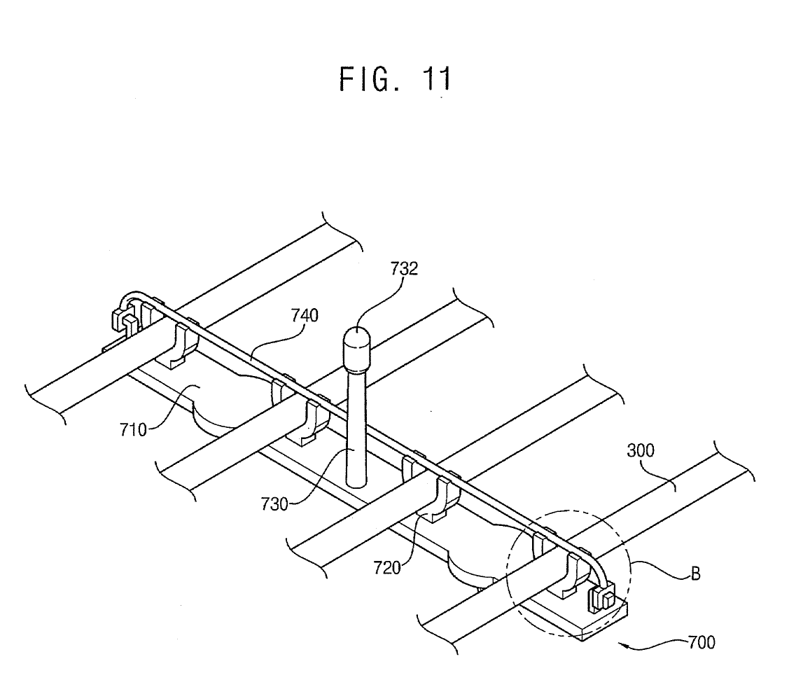

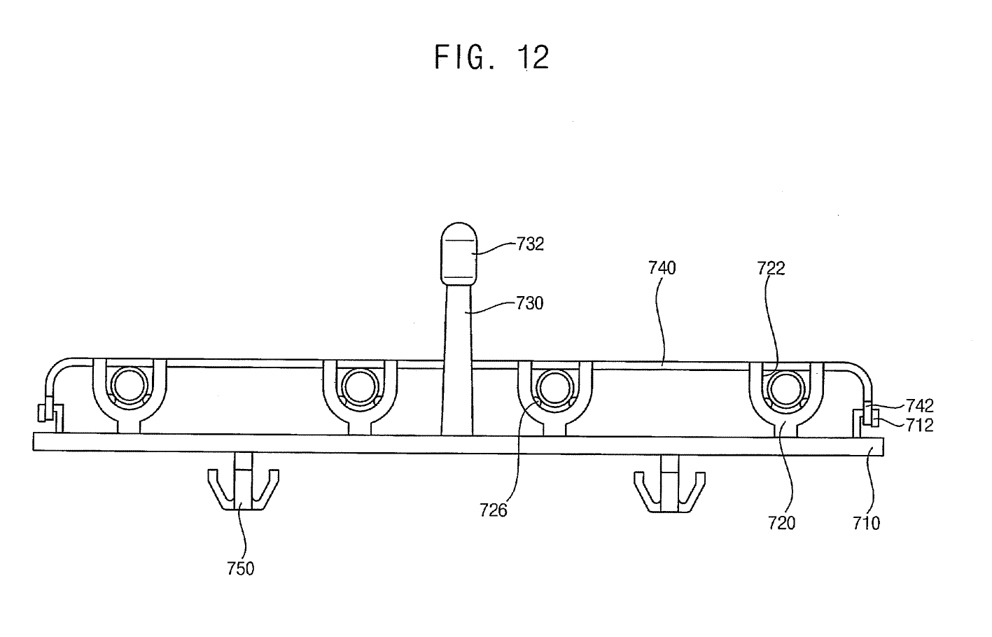

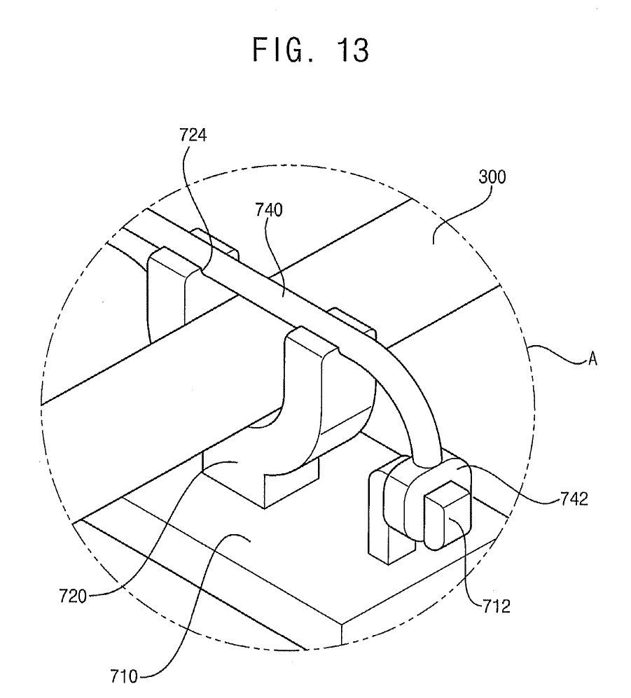

FIG. 11 is a perspective view illustrating still another exemplary embodiment of a lamp fixing member. FIG. 12 is a side view illustrating the lamp fixing member in FIG. 11. FIG. 13 is an enlarged view illustrating portion B in FIG. 11.

Referring to FIGS. 11, 12 and 13, a lamp fixing member 700 includes a body portion 710, a lamp fixing portion 720, a diffusion plate supporting portion 730 and a fixing band 740.

The body portion 710 extends along a direction that is substantially transverse or perpendicular to a longitudinal direction of the lamps 300. The body portion 710 includes a band combining portion 712 to be combined with the fixing band 740. The band combining portion 712 is disposed at both opposing edge portions of the body portion 710, and protrudes therefrom with a hook shape defining a bight or groove.

More than one lamp fixing portion 720 is disposed on an upper surface of the body portion 710. The lamp fixing portion 720 has a groove 722 to fix the lamp 300. For example, the groove 722 of the lamp fixing portion 720 has a larger size than that of the lamp 300 to be inserted and received therein.

The lamp fixing portion 720 may be disposed on both sides with respect to the diffusion plate supporting portion 730, and more than one lamp fixing portions 720 may be disposed on each side. For example, the lamp fixing member 700 may have two lamp fixing portions 720 disposed on each side with respect to the diffusion plate supporting portion 730, so that the lamp fixing member 700 may have four lamp fixing portions 720 in total. Alternatively, the lamp fixing member 700 may have a various number of lamp fixing portions 720.

The lamp fixing portion 720 has a band fixing groove 724 to fix the fixing band 740. The band fixing groove 724 is disposed on a top of the lamp fixing portion 720 for the fixing band 740 to fix the upper portion of the lamp 300, which is inserted into the groove 722 of the lamp fixing portion 720.

The lamp fixing portion 720 includes at least one contact protrusion 726 to reduce the contact region with the lamp 300. The contact protrusion 726 is disposed at an inner surface of the groove 722, and makes a point contact with the lamp 300, which is inserted into the groove 722. For example, for stable contact with the lamp 300, the contact protrusions 726 are disposed at both sides of the groove 722 with respect to the center of the groove 722.

The fixing band 740 is disposed on the upper portion of the lamp fixing portion 720, and fixes the upper portion of the lamp 300 inserted into the groove 722. The fixing band 740 includes a combining ring 742 to be combined with the band combining portion 712 of the body portion 710. The combining ring 742 is correspondingly disposed at both end portions of the fixing band 740 to the band combining portion 712 of the body portion 710. The combining ring 742 is inserted and fixed to the band combining portion 712 having a hook shape.

The fixing band 740 is formed of a material with a predetermined elasticity to absorb an external impact on the lamp 300. For example, the fixing band 740 may be formed of a silicone material. Furthermore, the fixing band 740 may have a thin string shape to minimize the direct contact portion with the lamp 300.

Therefore, the lamp 300, which is inserted into the groove 722 of the lamp fixing portion 720, is fixed with at least three points of contact (e.g., with the pair of contact protrusions 726 and the fixing band 740).

The contact protrusion 726 is formed on the lamp fixing portion 720, and the contact portion with the lamp 300 is minimized by using the thin string shape fixing band 740. Therefore, the temperature deviation between the fixed portion and the other portion of the lamp 300 may be reduced and deterioration of a display image, such as a dark portion due to the temperature deviation, may also be eliminated.

The diffusion plate supporting portion 730 is disposed on the upper surface of the body portion 710. The diffusion plate supporting portion 730 protrudes higher than the lamp fixing portion 720, and supports the diffusion plate 350 which is shown in FIG. 1. The diffusion plate 350 may sag as the size thereof increases. Therefore, the diffusion plate supporting portion 730 prevents the diffusion plate 350 from sagging, and maintains a uniform distance between the lamp 300 fixed with the lamp fixing portion 720 and the diffusion plate 350. For example, the diffusion plate supporting portion 730 may have a conical shape.

The body portion 710, the lamp fixing portion 720 and the diffusion plate supporting portion 730 may be formed of a same material and be integrally manufactured. For example, the body portion 710, the lamp fixing portion 720 and the diffusion plate supporting portion 730 may be formed of a plastic material, and are manufactured by an injection molding method.

Since the diffusion plate supporting portion 730 includes the plastic material which has a predetermined strength and hardness, wearing off or fracture of the diffusion plate 350 may be occur due to an external impact or vibration.

Therefore, to prevent wearing off or the fracture of the diffusion plate 350, the lamp fixing member 700 may include a diffusion plate cover 732. The diffusion plate cover 732 covers the top of the diffusion plate supporting portion 730. The diffusion plate cover 732 is formed of a silicone material with a predetermined elasticity to have a soft contact with the diffusion plate 350.

The lamp fixing member 700 includes at least one body combining portion 750 disposed beneath a lower surface of the body portion 710 for being combined with the receiving container 200, which is shown in FIG. 1. The body combining portion 750 having a hook shape, passes through the opening portion of the bottom plate 210, and is combined with the bottom plate 210. The body combining portion 750 may have various locations and numbers.

In exemplary embodiments, the lamp 300 is assembled by an automated manufacturing machine (not shown). First, the lamp fixing member 700 separated from the fixing band 740, is assembled to the receiving container 200. Then, the lamps 300 are inserted into the grooves 722 of the respective lamp fixing portions 720 by the automated manufacturing machine. Then, a combining ring 742 of the fixing band 740 is assembled to the band combining portion 712 of the body portion 710.

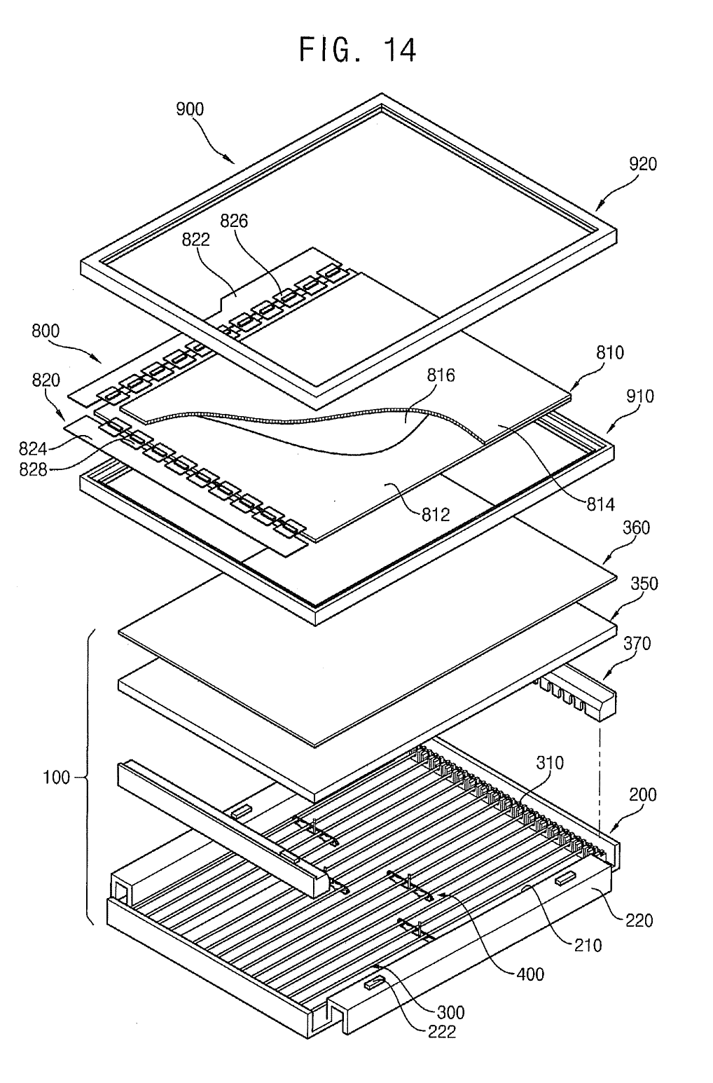

FIG. 14 is an exploded perspective view illustrating a LCD device according to an exemplary embodiment of the present invention.

Referring to FIG. 14, an LCD device according to an exemplary embodiment of the present invention, includes the backlight assembly 100 for supplying a light, a display unit 800 for displaying an image and a top chassis 920 for fixing the display unit 800.

The backlight assembly 100 of the present exemplary embodiment is the same as in the above-explained exemplary embodiments in FIGS. 1 through 14. Thus, the same reference numerals will be used to refer to the same or like parts as those described in the above-explained exemplary embodiments, and any further repetitive explanation concerning the above elements will be omitted.

The display unit 800 includes a liquid crystal display (“LCD”) panel 810 and a driving circuit portion 820. The LCD panel 810 displays an image by using light provided by the backlight assembly 100. The driving circuit portion 820 drives the LCD panel 810.

The LCD panel 810 includes a first substrate 812, a second substrate 814 combined with the first substrate 812, and a liquid crystal layer 816 disposed between the first and second substrates 812 and 814.

A plurality of thin film transistors (“TFT””), as switching elements, is disposed in a matrix array form on the first substrate 812. For example, the first substrate 812 includes a glass material. A data line is electrically connected to the source terminal of the TFT and a gate line is electrically connected to the gate terminal of the TFT. A pixel electrode including a transparent conductive material is electrically connected to a drain terminal of the TFT.

A RGB color filter to display a color image is formed on the second substrate 814. The RGB color filter has a thin film shape. The second substrate 814 includes, for example, a glass material. A common electrode including a transparent conductive material is formed on the second substrate 814.

In the LCD panel 810 having the above elements, an electric field is generated between the pixel electrode and the common electrode when a power supply is provided to the gate terminal of the TFT to turn on the TFT. The electric field changes an arrangement of liquid crystal molecules in the liquid crystal layer 816 disposed between the first and second substrates 812 and 814. The transmittance of the light provided by the backlight assembly 100 is changed according to the arrangement of liquid crystal molecules, thus various images are displayed.

The driving circuit portion 820 includes a data printed circuit board 822, a gate printed circuit board 824, a data driving circuit film 826 and a gate driving circuit film 828. The data printed circuit board 822 provides the LCD panel 810 with a data driving signal. The gate printed circuit board 824 provides the LCD panel 810 with a gate driving signal. The data driving circuit film 826 connects the data printed circuit board 822 with the LCD panel 810 and the gate driving circuit film 828 connects the gate printed circuit board 824 with the LCD panel 810.

The data driving circuit film 826 and the gate driving circuit film 828 include a driving chip. For example, a tape carrier package (“TCP”) or a chip on film (“COF”) may be employed as the data driving circuit film 826 and the gate driving circuit film 828.

The data driving circuit film 826 is bent such that the data printed circuit board 822 is disposed adjacent to the sidewall surface. Alternatively, the data driving circuit film 826 may be bent such that the data printed circuit board 822 is disposed beneath the surface of the receiving container 200. The gate driving circuit film 828 is bent such that the gate printed circuit board 824 is disposed adjacent to the sidewall surface. Alternatively, the gate driving circuit film 828 may be bent such that the gate printed circuit board 824 is disposed beneath the surface of the receiving container 200. The gate printed circuit board 824 may be eliminated by forming another wiring on both of the LCD panel 810 and the gate driving circuit film 828.

An LCD device 900 may include a middle mold 910 disposed between the optical sheet 360 and the LCD panel 810. The middle mold 910 fixes the optical sheet 360, the diffusion plate 350 and supports the LCD panel 810. The middle mold 910 is integrally formed to have a frame shape. Alternatively, the middle mold 910 may have a divided structure having two or four pieces.

A top chassis 920, which surrounds the edge portion of the LCD panel 810, is combined with the receiving container 200, and fixes the LCD panel 810 to the middle mold 910. The top chassis 920 prevents the LCD panel 810 from being broken by an external impact and from being broken away from the middle mold 910. The top chassis 920 is integrally formed. Alternatively, the top chassis 920 may have a divided structure having two or four pieces.

According to the present invention, the assemblage of the lamp may be enhanced by an automated manufacturing process.

Additionally, the temperature deviation on the fixed portion of the lamp may be reduced and deterioration such as a dark portion due to the temperature deviation may also be eliminated by using the lower supporting plate and the upper supporting plate of the lamp fixing member formed of a silicone material.

Furthermore, the temperature deviation between the fixed portion and the other portion of the lamp may be reduced and deterioration such as a dark portion due to the temperature deviation may also be eliminated by forming the contact protrusion on the lamp fixing member and using the thin string shape fixing band to minimize the contact region.

Having described the exemplary embodiments of the present invention and its advantages, it is noted that various changes, substitutions and alterations can be made herein without departing from the spirit and scope of the present invention as defined by the appended claims.

What is claimed is:

1. A lamp fixing member comprising:
a body portion;
at least one lamp fixing portion disposed on an upper surface of the body portion, and the lamp fixing portion having a groove for fixing a lamp;
a lower supporting plate combined with the lamp fixing portion, and fixing a lower portion of the lamp; and
an upper supporting plate combined with the lamp fixing portion, and fixing an upper portion of the lamp.

2. The lamp fixing member of claim 1, wherein the lamp fixing portion comprises a combining portion to be combined with the upper supporting plate and the lower supporting plate.

3. The lamp fixing member of claim 2, wherein the combining portion is disposed at least on one side of both sides of the lamp fixing portion with respect to the groove.

4. The lamp fixing member of claim 1, wherein the lower supporting plate comprises:
at least one lamp supporting portion fixed to the groove of the lamp fixing portion to support the lower portion of the lamp; and
a lower connecting portion connecting the lamp supporting portion with each other.

5. The lamp fixing member of claim 4, wherein the lower supporting plate comprises a lower combining hole for being combined with the lamp fixing portion.

6. The lamp fixing member of claim 5, wherein the lower combining hole includes lower combining holes disposed at both sides of the lower supporting plate with respect to the lamp supporting portion.

7. The lamp fixing member of claim 1, wherein the upper supporting plate comprises:
at least one lamp covering portion covering the upper portion of the lamp; and
an upper connecting portion connecting the lamp covering portion with each other.

8. The lamp fixing member of claim 7, wherein the upper supporting plate comprises an upper combining hole for being combined with the lamp fixing portion.

9. The lamp fixing member of claim 8, wherein the upper combining hole includes upper combining holes disposed at both sides of the upper supporting plate with respect to the lamp covering portion.

10. The lamp fixing member of claim 1, further comprising a diffusion plate supporting portion protruding from the upper surface of the body portion.

11. The lamp fixing member of claim 10, wherein the diffusion plate supporting portion has a conical shape.

12. The lamp fixing member of claim 10, wherein the lower supporting plate comprises a first hole into which the diffusion plate supporting portion is inserted to extend therethrough, and the upper supporting plate comprises a second hole into which the diffusion plate supporting portion is inserted to extend therethrough.

13. The lamp fixing member of claim 1, further comprising a body combining portion disposed under a lower surface of the body portion for being combined with a receiving container.

14. The lamp fixing member of claim 1, wherein the lower supporting plate and the upper supporting plate comprise a silicone material.

15. A lamp fixing member comprising:
a body portion;
at least one lamp fixing portion disposed on an upper surface of the body portion, and the lamp fixing portion having a groove for fixing a lamp;
a diffusion plate supporting portion disposed on the upper surface of the body portion and protruding beyond a height of the lamp fixing portion; and
a supporting plate disposed on an upper portion of the lamp fixing portion, the supporting plate fixing an upper portion of the lamp inserted into the groove.

16. The lamp fixing member of claim 15, wherein the lamp fixing portion comprises a first hook combining portion for being combined with the supporting plate.

17. The lamp fixing member of claim 16, wherein the supporting plate comprises a second hook combining portion for being combined with the first hook combining portion.

18. The lamp fixing member of claim 17, wherein the second hook combining portion is disposed at both opposing end portions of the supporting plate.

19. The lamp fixing member of claim 15, wherein the body portion comprises a third hook combining portion for being combined with the supporting plate.

20. The lamp fixing member of claim 19, wherein the supporting plate comprises a fourth hook combining portion for being combined with the third hook combining portion.

21. The lamp fixing member of claim 20, wherein the fourth hook combining portion is disposed at both opposing end portions of the supporting plate.

22. The lamp fixing member of claim 20, wherein the lamp fixing portion comprises a combining protrusion for being combined with the supporting plate.

23. The lamp fixing member of claim 22, wherein the supporting plate comprises a combining hole for being combined with the combining protrusion.

24. The lamp fixing member of claim 15, wherein the supporting plate has a first width, and a second width that is smaller than the first width at a region corresponding to the lamp fixing portion to reduce a direct contact region with the lamp.

25. The lamp fixing member of claim 15, wherein the supporting plate comprises a diffusion plate hole, into which the diffusion plate supporting portion is inserted to extend therethrough.

26. The lamp fixing member of claim 15, wherein the supporting plate comprises a silicone material.

27. The lamp fixing member of claim 15, further comprising a body combining portion disposed under a lower surface of the body portion for being combined with a receiving container.

28. A lamp fixing member comprising:
a body portion;
at least one lamp fixing portion disposed on an upper surface of the body portion, the lamp fixing portion having a groove for fixing a lamp;
a diffusion plate supporting portion disposed on the upper surface of the body portion and protruding beyond a height of the lamp fixing portion; and
a fixing band having a string shape inserted into the groove of the lamp fixing portion, fixing an upper portion of the lamp.

29. The lamp fixing member of claim 28, wherein the body portion comprises a band combining portion for being combined with the fixing band and both ends of the band combining portion protruding from both opposing edge portions of the body portion with a hook shape.

30. The lamp fixing member of claim 29, wherein the fixing band is disposed at both edge portions, and comprises a combining ring for combining with the band combining portion.

31. The lamp fixing member of claim 28, wherein the lamp fixing portion comprises a band fixing groove for fixing a position of the fixing band.

32. The lamp fixing member of claim 28, wherein the groove is disposed on an inner surface of the lamp fixing portion, and the inner surface of the lamp fixing portion comprises at least one contact protrusion which makes a point contact with the lamp.

33. The lamp fixing member of claim 28, wherein the fixing band comprises a silicone material.

34. The lamp fixing member of claim 28, further comprising a diffusion plate cover formed of a silicone material, the diffusion plate cover being inserted onto the diffusion plate supporting portion.

35. The lamp fixing member of claim 28, further comprising the body combining portion disposed on a lower surface of the body portion for being combined with a receiving container.

36. A backlight assembly comprising:
a receiving container having a bottom plate and a sidewall providing a receiving space;
a plurality of lamps disposed on the bottom plate of the receiving container;
a diffusion plate disposed over the plurality of lamps; and
a lamp fixing member comprising:
a body portion combined with the bottom plate of the receiving container, the body portion extending along a direction that is substantially perpendicular to a longitudinal direction of the lamps;
at least one lamp fixing portion disposed on an upper surface of the body portion, the lamp fixing portion having a groove for fixing the plurality of lamps;
a lower supporting plate combined with the lamp fixing portion, and fixing a lower portion of a lamp; and
an upper supporting plate combined with the lamp fixing portion, and fixing an upper portion of the lamp.

37. The backlight assembly of claim 36, wherein the lamp fixing portion comprises at least one combining portion disposed at one or both sides with respect to the groove for being combined with the lower supporting plate and the upper supporting plate.

38. The backlight assembly of claim 37, wherein the lower supporting plate comprises:
at least one lamp supporting portion inserted into the groove of the lamp fixing portion, and fixing the lower portion of the lamp;
a lower connecting portion connecting the lamp supporting portion with each other; and
a lower combining hole disposed at one or both sides with respect to the lamp supporting portion for being combined with the combining portion of the lamp fixing portion.

39. The backlight assembly of claim 37, wherein the upper supporting plate comprises:
at least one lamp cover portion covering the upper portion of the lamp;
an upper connecting portion connecting the lamp cover portion with each other; and
an upper combining hole disposed at both sides with respect to the lamp covering portion for being combined with the combining portion of the lamp fixing portion.

40. The backlight assembly of claim 36, wherein the lamp fixing member further comprises:
a diffusion plate supporting portion protruding from the upper surface of the body portion, and supporting the diffusion plate; and
a body combining portion disposed on a lower surface of the body portion for being combined with the receiving container.

41. The backlight assembly of claim 40, wherein the lower supporting plate having a first hole into which the diffusion plate supporting portion is inserted therethrough, and the upper supporting plate having a second hole into which the diffusion plate supporting portion is inserted therethrough.

42. The backlight assembly of claim 36, wherein the lower supporting plate and the upper supporting plate comprise silicone material.

43. A backlight assembly comprising:
a receiving container;
a plurality of lamps received in the receiving container;
a diffusion plate disposed over the plurality of lamps; and
a lamp fixing member comprising:
a body portion being combined with the receiving container, the body portion extending along a direction that is substantially perpendicular to longitudinal direction of the lamps;
at least one lamp fixing portion disposed on an upper surface of the body portion, the lamp fixing portion having a groove for fixing the plurality of lamps;
a diffusion plate supporting portion disposed on the upper surface of the body portion, and supporting the diffusion plate; and
a supporting plate disposed on an upper portion of the lamp fixing portion, and the supporting plate fixing the upper portion of the lamp inserted into the groove.

44. The backlight assembly of claim 43, wherein the lamp fixing portion comprises a first hook combining portion for being combined with the supporting plate, and the supporting plate comprises a second hook combining portion disposed at both end portions of the supporting plate and combines with the first hook combining portion.

45. The backlight assembly of claim 43, wherein the body portion comprises a third hook combining portion at both end portions of the body portion for being combined with the supporting plate, and the supporting plate comprises a fourth hook combining portion disposed at both end portions of the supporting plate and being combined with the third hook combining portion.

46. The backlight assembly of claim 45, wherein the lamp fixing portion comprises a combining protrusion for being combined with the supporting plate, and the supporting plate comprises a combining hole being combined with the combining protrusion.

47. The backlight assembly of claim 43, wherein the supporting plate comprises a diffusion plate hole into which the diffusion plate supporting portion is inserted therethrough.

48. The backlight assembly of claim 43, wherein the supporting plate comprises silicone material.

49. A backlight assembly comprising:
a receiving container;
a plurality of lamps received in the receiving container;
a diffusion plate disposed over the plurality of lamps; and
a lamp fixing member comprising:
a body portion being combined with the receiving container, the body portion extending along a direction that is substantially perpendicular to a longitudinal direction of the lamps;
at least one lamp fixing portion disposed on an upper surface of the body portion, and the lamp fixing portion having a groove for fixing a respective lamp of the plurality of lamps;
a diffusion plate supporting portion disposed on the upper surface of the body portion, and supporting the diffusion plate; and
a fixing band inserted into the groove of the lamp fixing portion, the fixing band having a string shape and fixing an upper portion of the lamp.

50. The backlight assembly of claim 49, wherein the body portion comprises a band combining portion for being combined with the fixing band and both ends of the band combining portion protrudes from the body portion to have a hook shape, and the fixing band is disposed at both end portions and comprises a combining ring for being combined with the band combining portion.

51. The backlight assembly of claim 49, wherein the first groove is disposed on an inner surface of the lamp fixing portion, and the inner surface of the lamp fixing portion comprises at least one contact protrusion that makes a point contact with the lamp.

52. The backlight assembly of claim 49, wherein the fixing band comprises a silicone material.

53. The backlight assembly of claim 49, further comprising a diffusion plate cover including a silicone material and inserted onto an upper portion of the diffusion plate supporting portion.

54. A liquid crystal display device comprising:
a backlight assembly for providing light;
a display unit disposed over the backlight assembly for displaying an image; and
a top chassis fixing the display unit,
wherein the backlight assembly comprises:
a receiving container;
a plurality of lamps arranged in parallel and received on a bottom plate of the receiving container; and
a lamp fixing member including a body portion being combined with the bottom plate of the receiving container and extending along a direction substantially perpendicular to a longitudinal direction of the lamps, at least one lamp fixing portion disposed on an upper surface of the body portion and having a groove for fixing a lamp of the plurality of lamps, a lower supporting plate being combined with the lamp fixing portion and fixing a lower portion of the lamp, and an upper supporting plate being combined with the lamp fixing portion and fixing an upper portion of the lamp.

55. A liquid crystal display device comprising:
a backlight assembly for providing light;
a display unit disposed over the backlight assembly for displaying an image; and
a top chassis fixing the display unit,
wherein the backlight assembly comprises:
a receiving container;
a plurality of lamps received on a bottom plate of the receiving container;
a diffusion plate disposed over the plurality of lamps; and
a lamp fixing member including a body portion being combined with the receiving container and extending along a direction substantially perpendicular to a longitudinal direction of the lamps, at least one lamp fixing portion disposed on an upper surface of the body portion and having a groove for fixing a lamp of the plurality of lamps, a diffusion plate supporting portion disposed on the upper surface of the body portion and supporting the diffusion plate, and a supporting plate disposed on an upper portion of the lamp fixing portion and fixing an upper portion of the lamp inserted into the groove.

56. A liquid crystal display device comprising:
a backlight assembly for providing a light;
a display unit disposed over the backlight assembly for displaying an image; and
a top chassis fixing the display unit,
wherein the backlight assembly comprises:
a receiving container;
a plurality of lamps received on a bottom plate of the receiving container;
a diffusion plate disposed over the plurality of lamps; and
a lamp fixing member including a body portion being combined with the receiving container and extending along a direction substantially perpendicular to a longitudinal direction of the plurality of lamps, at least one lamp fixing portion disposed on an upper surface of the body portion and having a groove for fixing a lamp of the plurality of lamps, a diffusion plate supporting portion disposed on the upper surface of the body portion and supporting the diffusion plate, and a fixing band inserted into the groove of the lamp fixing portion, the fixing band having a string shape and fixing an upper portion of the lamp.
